(19) United States
(12) Patent Application Publication
(10) Pub. No.: US 2020/0198626 A1
(43) Pub. Date: Jun. 25, 2020

(54) VEHICLE CONTROLLER, VEHICLE, AND VEHICLE CONTROL METHOD

(71) Applicant: TOYOTA JIDOSHA KABUSHIKI KAISHA, Toyota-shi (JP)

(72) Inventors: Takuro YANAGI, Toyota-shi (JP); Maki Tamura, Nisshin-shi (JP); Mutsumi Matsuura, Okazaki-shi (JP); Toshihiko Inoue, Toyota-shi (JP); Naoki Yamamuro, Nagoya-shi (JP); Takashi Hayashi, Aichi-gun (JP); Takahiro Shiga, Chiryu-shi (JP)

(73) Assignee: TOYOTA JIDOSHA KABUSHIKI KAISHA, Toyota-shi (JP)

(21) Appl. No.: 16/659,625

(22) Filed: Oct. 22, 2019

(30) Foreign Application Priority Data
Dec. 21, 2018 (JP) 2018-240123

(51) Int. Cl. B60W 30/09; G05D 1/00

(52) U.S. Cl. CPC B60W 30/09; B60W 2420/42; G05D 1/0088

(57) ABSTRACT

A vehicle controller includes a control unit. The control unit detects a target that moves in a direction to approach a vehicle from an image captured from the vehicle. Based on a detection result, the control unit determines whether the vehicle should evacuate in order to let the target pass by. When determining that the vehicle should evacuate, the control unit causes the vehicle to evacuate without waiting for an operation by a driver.

### INCORPORATION BY REFERENCE

The disclosure of Japanese Patent Application No. 2018-240123 filed on Dec. 21, 2018 including the specification, drawings and abstract is incorporated herein by reference in its entirety.

### BACKGROUND

### 1. Technical Field

The present disclosure relates to a vehicle controller, a vehicle, and a vehicle control method.

### 2. Description of Related Art

In the case where a target such as an emergency vehicle approaches a host vehicle from behind during operation of the host vehicle, the host vehicle should pull over to a road side or should change a lane. However, there is a case where the driver is late for noticing the target and, as a result, unintentionally interferes with smooth travel of the target.

In Japanese Patent Application Publication No. 11-306494 (JP 11-306494 A), a technique of detecting the emergency vehicle, which approaches the host vehicle from behind, by using a camera or a microphone and informing a driver of the approach of the emergency vehicle by a video, characters, or voice is disclosed.

In JP 2008-052341 A, a technique of notifying a driver of a normal vehicle, which travels toward an intersection, of an approaching direction of the emergency vehicle and providing the driver with an evacuation instruction according to the approaching direction when a video that is captured by a surveillance camera installed at an intersection includes the emergency vehicle is disclosed.

### SUMMARY

In the background art, when the driver is notified of the approach of the emergency vehicle or receives the evacuation instruction, the driver possibly becomes too flustered to evacuate promptly and, as a result, possibly interfere with the smooth travel of the emergency vehicle. In such a case, there is also a possibility that the driver fails to evacuate and the normal vehicle collides with the emergency vehicle.

The present disclosure has a purpose of suppressing a delay in evacuation or failure in evacuation at the time when a vehicle should evacuate in order to let a target that travels in a direction to approach the vehicle pass by.

A vehicle controller according to an aspect of the present disclosure includes a control unit that detects a target moving in a direction to approach a vehicle from an image captured from the vehicle, determines whether the vehicle should evacuate in order to let the target pass by on the basis of a detection result, and causes the vehicle to evacuate without waiting for an operation by a driver when determining that the vehicle should evacuate.

A vehicle control method according to another aspect of the present disclosure includes: capturing an image from a vehicle by a capturing unit; detecting a target that moves in a direction to approach the vehicle from the image by a control unit; determining whether the vehicle should evacuate in order to let the target pass by on the basis of a detection result of the target by the control unit; and causing the vehicle to evacuate without waiting for an operation by a driver in the case where the control unit determines that the vehicle should evacuate.

According to the aspects of the present disclosure, a delay in evacuation or failure in evacuation is unlikely to occur when the vehicle should evacuate in order to let the target, which travels in the direction to approach the vehicle, pass by.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a view of an example in which a vehicle according to an embodiment of the present disclosure avoids an emergency vehicle;

FIG. 2 is a view of an example in which the vehicle according to the embodiment of the present disclosure avoids the emergency vehicle;

FIG. 3 is a view of an example in which the vehicle according to the embodiment of the present disclosure avoids the emergency vehicle;

FIG. 4 is a block diagram illustrating a configuration of the vehicle according to the embodiment of the present disclosure; and

FIG. 5 is a flowchart illustrating operation of a vehicle controller according to the embodiment of the present disclosure.

### DETAILED DESCRIPTION OF EMBODIMENTS

A description will hereinafter be made on an embodiment of the present disclosure with reference to the drawings.

In the drawings, the same or corresponding portions are denoted by the same reference numerals and symbols. In this embodiment, a description on the same or corresponding portions will appropriately be simplified or will not be made.

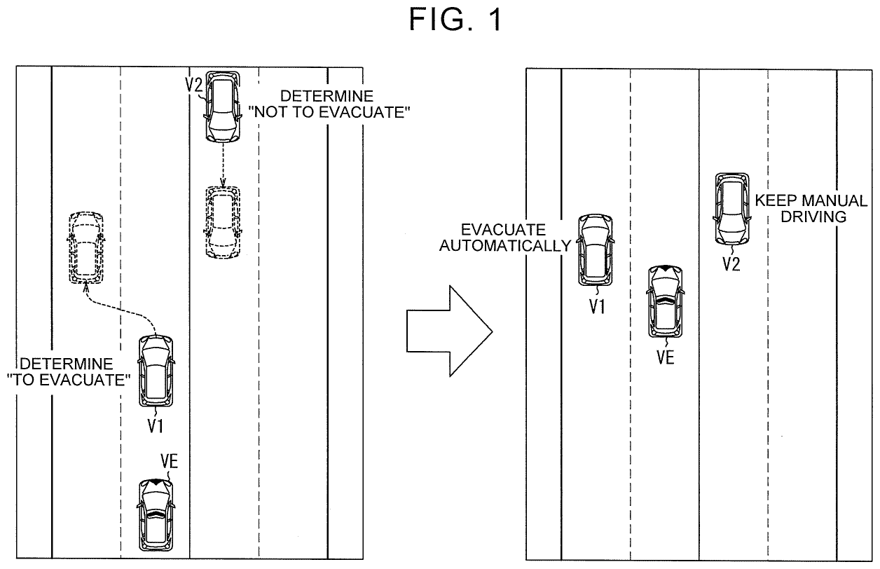

A description will be made on an overview of this embodiment with reference to FIG. 1 to FIG. 3.

A first vehicle V1 detects, as a target that moves in a direction to approach the first vehicle V1, a different vehicle from the first vehicle V1, more specifically, an emergency vehicle VE. Based on a detection result, the first vehicle V1 determines whether to evacuate in order to let the emergency vehicle VE pass by. When determining to evacuate, the first vehicle V1 automatically evacuates without waiting for an operation by a driver. Thus, according to this embodiment, even when the driver is late for noticing the emergency vehicle VE, or even when the driver notices the emergency vehicle VE and, as a result, becomes flustered, the first vehicle V1 can evacuate to let the emergency vehicle VE travel smoothly.

In examples illustrated in FIG. 1 to FIG. 3, the first vehicle V1 is an automobile. However, the first vehicle V1 may be another type of the vehicle.

In the examples illustrated in FIG. 1 to FIG. 3, the emergency vehicle VE is a police car. However, the emergency vehicle VE may be another type of the emergency vehicle such as an ambulance or a fire engine.

The first vehicle V1 may detect, as the target that moves in the direction to approach the first vehicle V1, a vehicle other than the emergency vehicle VE, such as a runaway vehicle or a dangerous driving vehicle that intensely rushes a vehicle in front. In such a case, based on the detection result, the first vehicle V1 determines whether to evacuate in order to let such a vehicle pass by. When determining to evacuate, the first vehicle V1 automatically evacuates without waiting for the operation by the driver.

The first vehicle V1 may detect, as the target that moves in the direction to approach the first vehicle V1, an animal such as a cow running wild or a horse running wild. In such a case, based on the detection result, the first vehicle V1 determines whether to evacuate in order to let such an animal pass by. When determining to evacuate, the first vehicle V1 automatically evacuates without waiting for the operation by the driver.

A second vehicle V2 is the same as the first vehicle V1. Thus, a description thereon will not be made.

FIG. 1 illustrates an example in which the first vehicle V1 avoids the emergency vehicle VE on a two-lane road on either side.

The first vehicle V1 currently travels in a manual driving mode on a passing lane. On the same lane as the first vehicle V1, the emergency vehicle VE currently makes emergency travel behind the first vehicle V1.

The first vehicle V1 detects the emergency vehicle VE that approaches the first vehicle V1 from behind. Since the emergency vehicle VE currently makes the emergency travel on the same lane as the first vehicle V1, the first vehicle V1 determines to evacuate in order to let the emergency vehicle VE pass by. The first vehicle V1 switches a driving mode from the manual driving mode to an automated driving mode. To evacuate, the first vehicle V1 changes the lane from the passing lane to a traveling lane. After letting the emergency vehicle VE pass by, the first vehicle V1 switches the driving mode from the automated driving mode to the manual driving mode.

In the case where the first vehicle V1 detects the emergency vehicle VE during travel in the automated driving mode, the driving mode is not required to be switched.

In the example illustrated in FIG. 1, the second vehicle V2 currently travels in the manual driving mode on an opposite lane from the first vehicle V1.

The second vehicle V2 detects the emergency vehicle VE that approaches the second vehicle V2 from the front. Since the emergency vehicle VE currently travels on the opposite lane from the second vehicle V2, the second vehicle V2 determines not to evacuate in order to let the emergency vehicle VE pass by. The second vehicle V2 maintains the manual driving mode.

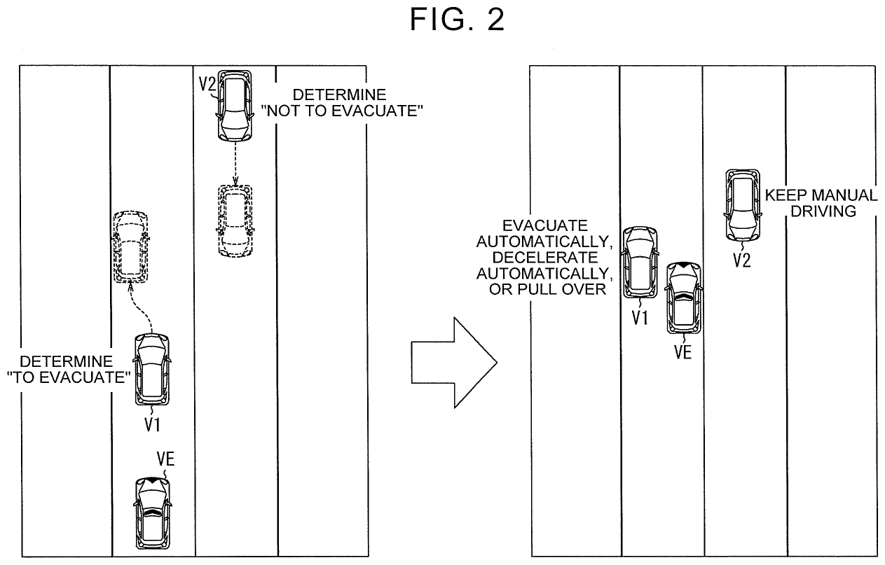

FIG. 2 illustrates an example in which the first vehicle V1 avoids the emergency vehicle VE on a one-lane road on either side.

The first vehicle V1 currently travels in the manual driving mode. On the same lane as the first vehicle V1, the emergency vehicle VE currently makes the emergency travel behind the first vehicle V1.

The first vehicle V1 detects the emergency vehicle VE that approaches the first vehicle V1 from behind. Since the emergency vehicle VE currently makes the emergency travel on the same lane as the first vehicle V1, the first vehicle V1 determines to evacuate in order to let the emergency vehicle VE pass by. In this example, according to a width of the lane, the first vehicle V1 determines to decelerate or pull over in order to let the emergency vehicle VE pass by safely. The first vehicle V1 switches the driving mode from the manual driving mode to the automated driving mode. The first vehicle V1 decelerates or pulls over while moving to a road side to evacuate. After letting the emergency vehicle VE pass by, the first vehicle V1 switches the driving mode from the automated driving mode to the manual driving mode.

In the case where the first vehicle V1 detects the emergency vehicle VE during the travel in the automated driving mode, the driving mode is not required to be switched.

In the example illustrated in FIG. 2, the second vehicle V2 currently travels in the manual driving mode on the opposite lane from the first vehicle V1.

Similar to the example illustrated in FIG. 1, the second vehicle V2 maintains the manual driving mode.

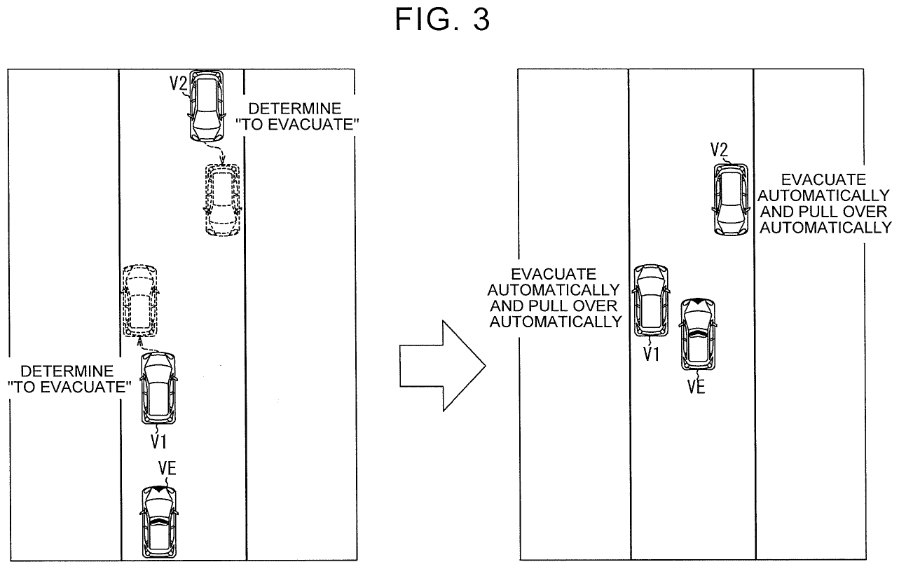

FIG. 3 illustrates an example in which the first vehicle V1 avoids the emergency vehicle VE on a one-lane road that permits two-way travel.

The first vehicle V1 currently travels in the manual driving mode. The emergency vehicle VE currently makes the emergency travel behind the first vehicle V1 in the same direction as the first vehicle V1.

The first vehicle V1 detects the emergency vehicle VE that approaches the first vehicle V1 from behind. Due to a narrow width of the road, the first vehicle V1 determines to evacuate and pull over in order to let the emergency vehicle VE pass by.

The first vehicle V1 switches the driving mode from the manual driving mode to the automated driving mode. The first vehicle V1 pulls over while moving to the road side to evacuate. After letting the emergency vehicle VE pass by, the first vehicle V1 switches the driving mode from the automated driving mode to the manual driving mode.

In the case where the first vehicle V1 detects the emergency vehicle VE during the travel in the automated driving mode, the driving mode is not required to be switched.

In the example illustrated in FIG. 3, the second vehicle V2 currently travels in the manual driving mode in an opposite direction from the first vehicle V1.

The second vehicle V2 detects the emergency vehicle VE that approaches the second vehicle V2 from the front. Due to the narrow width of the road, the second vehicle V2 determines to evacuate and pull over in order to let the emergency vehicle VE pass by. The second vehicle V2 switches the driving mode from the manual driving mode to the automated driving mode. The second vehicle V2 pulls over while moving to the road side to evacuate. After letting the emergency vehicle VE pass by, the second vehicle V2 switches the driving mode from the automated driving mode to the manual driving mode.

In the case where the second vehicle V2 detects the emergency vehicle VE during the travel in the automated driving mode, the driving mode is not required to be switched.

In this embodiment, the manual driving mode corresponds to the “level 1” or the “level 2” in the levels set by SAE, and the automated driving mode corresponds to the “level 3” or the “level 4” in the levels set by SAE. However, each of the manual driving mode and the automated driving mode may be in another level, or may be in a driving level that is set differently. “SAE” is an abbreviation for Society of Automotive Engineers.

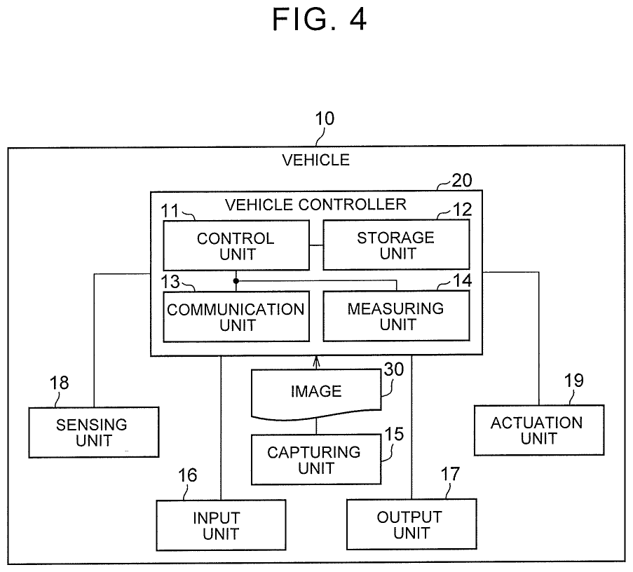

A description will be made on a configuration of a vehicle 10 according to this embodiment with reference to FIG. 4.

The first vehicle V1 and the second vehicle V2 in the examples illustrated in FIG. 1 to FIG. 3 each correspond to the vehicle 10.

The vehicle 10 includes a vehicle controller 20.

The vehicle controller 20 may be configured as an in-vehicle device such as a navigation system, or may be configured as an electronic device such as a smartphone that is connected to the in-vehicle device for use.

The vehicle controller 20 includes components that are a control unit 11, a storage unit 12, a communication unit 13, and a measuring unit 14.

The control unit 11 includes one or more processors. As the processor, a general-purpose processor such as a CPU or a dedicated processor that is specialized in particular processing can be used. The “CPU” is an abbreviation for Central Processing

Unit. The control unit 11 may include one or more dedicated circuits. Alternatively, in the control unit 11, the one or more processors may be replaced with the one or more dedicated circuits. As the dedicated circuit, a FPGA or an ASIC can be used, for example. The “FPGA” is an abbreviation for Field-Programmable Gate Array. The “ASIC” is an abbreviation for Application-Specific Integrated Circuit. The control unit 11 may include one or more ECUs. The “ECU” is an abbreviation for Electronic Control Unit. While controlling each section of the vehicle 10 including the vehicle controller 20, the control unit 11 executes information processing related to operation of the vehicle controller 20.

The storage unit 12 is one or more units of memory. As the memory, semiconductor memory, magnetic memory, or optical memory can be used, for example. The memory may function as a primary storage unit, an auxiliary storage unit, or cache memory. In the storage unit 12, information used for the operation of the vehicle controller 20 and information acquired by the operation of the vehicle controller 20 are stored.

The communication unit 13 is one or more communication modules. As the communication module, a communication module corresponding to a DSRC, LTE, 4G, or 5G can be used, for example. “DSRC” is an abbreviation for Dedicated Short-Range Communications. “LTE” is an abbreviation for Long-Term Evolution. “4G” is an abbreviation for 4th Generation. “5G” is an abbreviation for 5th Generation. The communication unit 13 receives the information used for the operation of the vehicle controller 20, and transmits the information acquired by the operation of the vehicle controller 20.

The measuring unit 14 is one or more measuring modules. As the measuring module, a measuring module corresponding to GPS, QZSS, GLONASS, or Galileo can be used, for example. The “GPS” is an abbreviation for Global Positioning System. The “QZSS” is an abbreviation for Quasi-Zenith Satellite System. A satellite used for the QZSS is referred to as a quasi-zenith satellite. The “GLONASS” is an abbreviation for Global Navigation Satellite System. The measuring unit 14 acquires location information of the vehicle 10.

A function of the vehicle controller 20 is realized when the processor provided in the control unit 11 executes a vehicle control program according to this embodiment. That is, the function of the vehicle controller 20 is realized by software.

The vehicle control program is a program that makes a computer execute processing in steps included in the operation of the vehicle controller 20, so as to make the computer realize the function corresponding to the processing in the steps. That is, the vehicle control program is a program that makes the computer function as the vehicle controller 20.

The program can be stored in a computer-readable recording medium. As the computer-readable recording medium, a magnetic recorder, an optical disc, a magneto-optical recording medium, or the semiconductor memory can be used, for example. The program is distributed by selling, giving, or lending a portable recording medium such as a DVD or a CD-ROM in which the program is recorded. The “DVD” is an abbreviation for Digital Versatile Disc. The “CD-ROM” is an abbreviation for Compact Disk Read Only Memory. The program may be distributed by storing the program in a server storage and transferring the program from the server to another computer via a network. The program may be provided as a program product.

The computer once stores the program, which is recorded in the portable recording medium, or the program, which is transferred from the server, in the memory, for example. Then, the computer reads the program, which is stored in the memory, by the processor and executes the processing according to the read program. The computer may directly read the program from the portable recording medium and execute the processing according to the program. Every time the program is transferred from the server to the computer, the computer may sequentially execute the processing according to the received program. The processing may be executed by a so-called ASP-type service that does not transfer the program from the server to the computer and realizes the function only by instructing the execution of the program and acquiring a result of the execution. The “ASP” is an abbreviation for Application Service Provider. The program includes information that is used for processing by an electronic computer and is equivalent to the program. For example, data that is not a direct instruction to the computer but has a property of defining the processing by the computer corresponds to that “equivalent to the program”.

A part or all of the function of the vehicle controller 20 may be realized by a dedicated circuit that is provided in the control unit 11. That is, the part or all of the function of the vehicle controller 20 may be realized by hardware.

In addition to the vehicle controller 20, the vehicle 10 includes a capturing unit 15, an input unit 16, an output unit 17, a sensing unit 18, and an actuation unit 19. In the vehicle 10, the capturing unit 15, the input unit 16, the output unit 17, the sensing unit 18, and the actuation unit 19 may be parts of the vehicle controller 20.

The capturing unit 15 is one or more in-vehicle cameras. As the in-vehicle camera, a front camera, a side camera, or a rear camera can be used, for example. One or more in-vehicle radars or one or more in-vehicle LiDAR units may be provided in the capturing unit 15. Alternatively, in the capturing unit 15, the one or more in-vehicle cameras may be replaced with the one or more in-vehicle radars or the one or more in-vehicle LiDAR units. “LiDAR” is an abbreviation for Light Detection and Ranging. The capturing unit 15 captures an image 30 from the vehicle 10. That is, the capturing unit 15 captures the image 30 on the outside of the vehicle 10.

The input unit 16 is one or more input interfaces. As the input interface, a physical key, a capacitive key, a pointing device, a touchscreen integrally provided with an in-vehicle display, or an in-vehicle microphone can be used, for example. The input unit 16 accepts input of the information, which is used for the operation of the vehicle controller 20, from a user such as a driver of the vehicle 10.

The output unit 17 is one or more output interfaces. As the output interface, the in-vehicle display or an in-vehicle speaker can be used, for example. As the in-vehicle display, a HUD, a LCD, or an organic EL display can be used, for example. The “HUD” is an abbreviation for Head-Up Display. The “LCD” is an abbreviation for Liquid Crystal Display. The “EL” is an abbreviation for Electroluminescence. The in-vehicle display has a display function. The output unit 17 outputs the information, which is acquired by the operation of the vehicle controller 20, to the user.

The sensing unit 18 is one or more sensors. As the sensor, a vehicle speed sensor, an acceleration sensor, a millimeter-wave sensor, or the microphone can be used, for example. The sensing unit 18 measures various phenomena in each of the sections of the vehicle 10, and acquires a measurement result as the information, which is used for the operation of the vehicle controller 20.

The actuation unit 19 is one or more actuators. As the actuator, a throttle actuator, a brake actuator, or a steering actuator can be used, for example. The actuation unit 19 operates each of the sections of the vehicle 10 according to the information acquired by the operation of the vehicle controller 20.

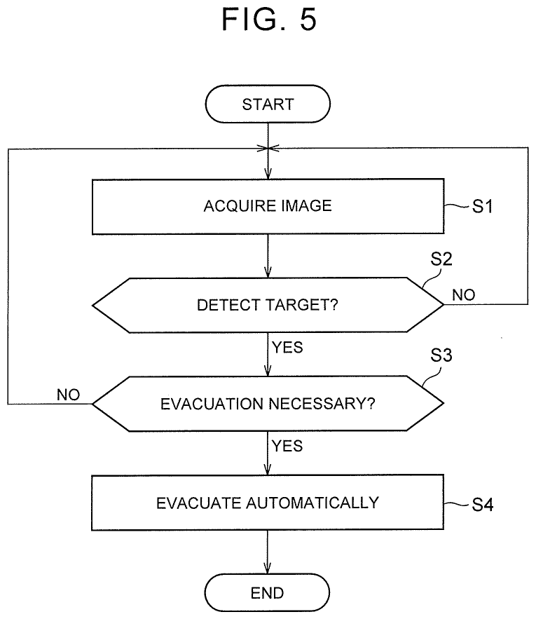

A description will be made on the operation of the vehicle controller 20 according to this embodiment with reference to FIG. 4 and FIG. 5. The operation of the vehicle controller 20 corresponds to a vehicle control method according to this embodiment.

In step S1, the control unit 11 acquires the image 30 that is captured from the vehicle 10.

More specifically, the control unit 11 acquires the images 30 in front of, on a side of, and at the rear of the vehicle 10 from the capturing unit 15. The control unit 11 stores the acquired images 30 in the storage unit 12.

In step S2, the control unit 11 detects the target that moves in a direction to approach the vehicle 10 from the images 30 acquired in step S1.

More specifically, the control unit 11 analyzes the images 30, which are stored in the storage unit 12, and determines whether the emergency vehicle is captured in any of the images 30. If the emergency vehicle is captured in any of the images 30, the control unit 11 determines whether the emergency vehicle currently travels in the direction to approach the vehicle 10. As a technique of recognizing the emergency vehicle in any of the images 30, machine learning, pattern matching, extraction of a characteristic point, or an image recognition technique, in which these techniques are combined, can be used, for example. The determination on whether the emergency vehicle in any of the images 30 currently travels in the direction to approach the vehicle 10 may be made by simply determining whether a front portion of the emergency vehicle is captured in any of the images 30, or may be determined by analyzing a video image or plural static images as the images 30 for a temporal change in a relative position of the emergency vehicle to the vehicle 10.

The control unit 11 may detect another type of the target such as the animal instead of detecting the different vehicle from the vehicle 10, such as the emergency vehicle.

The processing in step S1 and step S2 is repeatedly executed until the target that moves in the direction to approach the vehicle 10 is detected. When such a target is detected, processing in step S3 is executed.

In step S3, based on the detection result in step S2, the control unit 11 determines whether the vehicle 10 should evacuate to let the target, which is detected in step S2, pass by.

More specifically, the control unit 11 determines whether items, such as a positional relationship between the vehicle 10 and the emergency vehicle detected in step S2, an advancing direction of each of the vehicles, a type and the width of the traveling road or lane, and presence or absence of siren sound from the emergency vehicle, satisfy conditions to cause the vehicle 10 to evacuate in order to let the emergency vehicle pass by. Each of the items is recognized by analyzing the images 30 acquired in step S1, referring to map information stored in advance in the storage unit 12, referring to the location information of the vehicle 10 acquired from the measuring unit 14, or analyzing sound on the outside of the vehicle 10, which is sensed by the microphone provided in the sensing unit 18. Each of the conditions is set in advance in consideration of safety and in conformity with Road Traffic Act of Japan or traffic regulations of a country when the vehicle 10 travels in the country other than Japan.

In the example illustrated in FIG. 1, since the first vehicle V1 currently travels on the passing lane of the two-lane road on either side and the emergency vehicle VE currently makes the emergency travel behind the first vehicle V1 on the same lane as the first vehicle V1, the control unit 11 in the first vehicle V1 determines that the conditions to cause the first vehicle V1 to evacuate in order to let the emergency vehicle VE pass by are satisfied. Meanwhile, since the second vehicle V2 currently travels on the passing lane of the two-lane road on either side and the emergency vehicle VE currently travels in front of the second vehicle V2 on the opposite lane from the second vehicle V2, the control unit 11 in the second vehicle V2 determines that the conditions to cause the second vehicle V2 to evacuate in order to let the emergency vehicle VE pass by are not satisfied.

In the example illustrated in FIG. 2, since the first vehicle V1 currently travels on the one-lane road on either side and the emergency vehicle VE currently makes the emergency travel behind the first vehicle V1 on the same lane as the first vehicle V1, the control unit 11 in the first vehicle V1 determines that the conditions to cause the first vehicle V1 to evacuate in order to let the emergency vehicle VE pass by are satisfied.

Meanwhile, since the second vehicle V2 currently travels on the one-lane road on either side and the emergency vehicle VE currently travels in front of the second vehicle V2 on the opposite lane from the second vehicle V2, the control unit 11 in the second vehicle V2 determines that the conditions to cause the second vehicle V2 to evacuate in order to let the emergency vehicle VE pass by are not satisfied.

In the example illustrated in FIG. 3, since the first vehicle V1 currently travels on the narrow one-lane road and the emergency vehicle VE currently makes the emergency travel behind the first vehicle V1 in the same direction as the first vehicle V1, the control unit 11 in the first vehicle V1 determines that the conditions to cause the first vehicle V1 to evacuate in order to let the emergency vehicle VE pass by are satisfied.

Since the second vehicle V2 currently travels on the narrow one-lane road and the emergency vehicle VE currently makes the emergency travel in front of the second vehicle V2 in the opposite direction from the second vehicle V2, the control unit 11 in the second vehicle V2 determines that the conditions to cause the second vehicle V2 to evacuate in order to let the emergency vehicle VE pass by are satisfied.

In this embodiment, the control unit 11 also determines whether the vehicle 10 should decelerate or pull over when necessary.

More specifically, the control unit 11 determines whether items, such as the type and the width of the road or the lane and presence or absence of the intersection ahead of the vehicle 10, satisfy conditions to cause the vehicle 10 to decelerate or pull over during the evacuation. Each of the items is recognized by analyzing the images 30 acquired in step S1, referring to the map information stored in advance in the storage unit 12, or referring to the location information of the vehicle 10 acquired from the measuring unit 14. Each of the conditions is set in advance in consideration of the safety and in conformity with Road Traffic Act of Japan or traffic regulations of the country when the vehicle 10 travels in the country other than Japan.

In the example illustrated in FIG. 1, since the first vehicle V1 can evacuate to an adjacent lane, the control unit 11 in the first vehicle V1 determines that the conditions to cause the first vehicle V1 to decelerate or pull over during the evacuation are not satisfied.

In the example illustrated in FIG. 2, the control unit 11 in the first vehicle V1 determines whether the conditions to cause the first vehicle V1 to decelerate or pull over during the evacuation are satisfied according to the width of the lane.

In the example illustrated in FIG. 3, due to the narrow width of the road, the control unit 11 in the first vehicle V1 determines that the conditions to cause the first vehicle V1 to pull over during the evacuation are satisfied. Due to the narrow width of the road, the control unit 11 in the second vehicle V2 also determines that the conditions to cause the second vehicle V2 to pull over during the evacuation are satisfied.

In the case where the control unit 11 determines that the conditions to cause the vehicle 10 to evacuate in order to let the emergency vehicle pass by are satisfied, the control unit 11 decides the adjacent lane or the road side, such as a shoulder, when the adjacent lane is unavailable as an evacuation place. In this embodiment, the control unit 11 decides the evacuation place while avoiding the intersection. For example, in the case where there is the intersection ahead of and near the vehicle 10, the control unit 11 decides a place behind the intersection as the evacuation place, and determines that the vehicle 10 should stop at the evacuation place regardless of the width of the road or the lane.

The processing in step S1 to step S3 is repeatedly executed until it is determined that the vehicle 10 should evacuate. In the case where it is determined that the vehicle 10 should evacuate, processing in step S4 is executed.

In step S4, the control unit 11 causes the vehicle 10 to evacuate without waiting for the operation by the driver. That is, the control unit 11 causes the vehicle 10 to evacuate automatically.

In this embodiment, even when the operation by the driver is performed, the control unit 11 overrides such an operation and causes the vehicle 10 to evacuate. That is, the control unit 11 forcibly causes the vehicle 10 to evacuate. For example, in the case where the vehicle 10 is in the manual driving mode, the control unit 11 forcibly switches the driving mode of the vehicle 10 to the automated driving mode.

More specifically, the control unit 11 decides a steering amount to cause the vehicle 10 to move to the evacuation place, which is decided in step S3. A distance to the evacuation place is detected by the in-vehicle camera, the in-vehicle radar, or the in-vehicle LiDAR provided in the capturing unit 15 or the millimeter-wave sensor provided in the sensing unit 18. Even when the distance is the same, a temporal change in the steering amount varies by a vehicle speed. The vehicle speed is detected by the vehicle speed sensor provided in the sensing unit 18. The control unit 11 controls a steering actuator provided in the actuation unit 19 according to the decided steering amount, so as to rotationally drive a steering shaft of the vehicle 10 such that the vehicle 10 moves to the evacuation place.

In the case where the evacuation place is located on the adjacent lane, the control unit 11 controls the steering actuator provided in the actuation unit 19 at least until the emergency vehicle passes by after the evacuation of the vehicle 10 when necessary. In this way, the control unit 11 adjusts a drive amount and a driving direction of the steering shaft of the vehicle 10 such that the vehicle 10 does not move out of the evacuation lane.

During the evacuation of the vehicle 10, the control unit 11 controls a brake actuator provided in the actuation unit 19 when necessary. In this way, the control unit 11 brakes each wheel of the vehicle 10 such that the vehicle 10 decelerates or pulls over. Alternatively, during the evacuation of the vehicle 10, the control unit 11 controls a throttle actuator provided in the actuation unit 19 when necessary. In this way, the control unit 11 reduces a throttle opening degree such that the vehicle 10 decelerates or pulls over.

In the example illustrated in FIG. 1, the control unit 11 in the first vehicle V1 causes the first vehicle V1 to evacuate by changing the lane of the first vehicle V1 from the passing lane to the traveling lane.

In the example illustrated in FIG. 2, the control unit 11 in the first vehicle V1 causes the first vehicle V1 to evacuate and also causes the first vehicle V1 to decelerate or pull over by causing the first vehicle V1 to move to the road side.

In the example illustrated in FIG. 3, the control unit 11 in the first vehicle V1 causes the first vehicle V1 to evacuate and also causes the first vehicle V1 to pull over by causing the first vehicle V1 to move to the road side. The control unit 11 in the second vehicle V2 causes the second vehicle V2 to evacuate and also causes the second vehicle V2 to pull over by causing the second vehicle V2 to move to the road side.

As described above, in this embodiment, the capturing unit 15 captures the images 30 from the vehicle 10. Then, the control unit 11 detects the target that moves in the direction to approach the vehicle 10 from the images 30. Based on the detection result, the control unit 11 determines whether the vehicle 10 should evacuate in order to let the target pass by. When determining that the vehicle 10 should evacuate, the control unit 11 causes the vehicle 10 to evacuate without waiting for the operation by the driver. Thus, according to this embodiment, even when the driver is late for noticing the target, or even when the driver notices the target and, as a result, becomes flustered, the first vehicle V1 can evacuate to let the target pass by smoothly. That is, a delay in the evacuation or failure in the evacuation is unlikely to occur when the vehicle 10 should evacuate in order to let the target, which travels in the direction to approach the vehicle 10, pass by.

An applicable embodiment of the present disclosure is not limited to the above-described embodiment. For example, plural blocks illustrated in the block diagram may be combined, or at least one of the plural blocks may be divided. In addition, instead of executing the plural steps described in the flowchart in chronological order according to the description, the plural steps may be executed in parallel or in a different order according to processing capacity of the units executing the steps or when necessary. Other modifications can also be made without departing from the gist of the present disclosure.

What is claimed is:

1. A vehicle controller comprising:
a control unit that detects a target moving in a direction to approach a vehicle from an image captured from the vehicle, determines whether the vehicle should evacuate in order to let the target pass by on the basis of a detection result, and causes the vehicle to evacuate without waiting for an operation by a driver when determining that the vehicle should evacuate.

2. The vehicle controller according to claim 1, wherein
even in the case where the operation by the driver is performed, the control unit overrides such an operation and causes the vehicle to evacuate when determining that the vehicle should evacuate.

3. The vehicle controller according to claim 1, wherein
the control unit detects, as the target, a different vehicle from the vehicle.

4. The vehicle controller according to claim 3, wherein
the control unit detects an emergency vehicle as the different vehicle from the vehicle.

5. The vehicle controller according to claim 1, wherein
the control unit detects an animal as the target.

6. A vehicle comprising:
a capturing unit that captures the image; and
a control unit that detects a target moving in a direction to approach a vehicle from an image captured from the vehicle, determines whether the vehicle should evacuate in order to let the target pass by on the basis of a detection result, and causes the vehicle to evacuate without waiting for an operation by a driver when determining that the vehicle should evacuate.

7. A vehicle control method comprising:
capturing an image from a vehicle by a capturing unit;
detecting a target that moves in a direction to approach the vehicle from the image by a control unit;
determining whether the vehicle should evacuate in order to let the target pass by on the basis of a detection result of the target by the control unit; and
causing the vehicle to evacuate without waiting for an operation by a driver in the case where the control unit determines that the vehicle should evacuate.
